(19) United States
(12) Patent Application Publication
(10) Pub. No.: US 2007/0225960 A1
(43) Pub. Date: Sep. 27, 2007

(54) SUBCHIP BOUNDARY CONSTRAINTS FOR CIRCUIT LAYOUT

(76) Inventors: Robert J. Greener, Chippewa Falls, WI (US); Chris Gorzek, Eau Claire, WI (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/277,569

(22) Filed: Mar. 27, 2006

(51) Int. Cl. G06F 17/50

(52) U.S. Cl. 703/19

(57) ABSTRACT

An electric circuit is laid out through a process comprising estimating signal propagation time in an interface between a source and a destination subcircuit, calculating a margin time based on the difference between a clock period and the estimated signal propagation time, and distributing the calculated margin time to at least one of the source and destination subcircuits.

### FIELD OF THE INVENTION

The invention relates generally to laying out electronic circuits, and more specifically in one embodiment to generation of subchip element boundary constraints for laying out electronic circuits.

### BACKGROUND OF THE INVENTION

Electronic circuits typically utilize various electronic components arranged in a useful way to form a useful circuit or arrangement of components. Common circuits include analog circuits, such as those designed to create, modulate, filter, or otherwise process analog signals that have values that are designed to vary across a continuous range of voltage levels. Also, digital circuits are made up of components designed to process digital information, which has one of a discrete number of values. Typical digital computers, for example, use components to handle digital signals varying between a reference voltage level of zero volts and a single higher voltage level, such as 3.3 volts.

But, in reality, the components that are used to make analog and digital circuits are not perfect, and the conductive traces that link various circuit elements themselves are not perfect. Printed circuit boards and integrated circuits alike suffer from resistance, capacitance, and inductance that are not intended but are a natural part of the circuit.

A capacitor employed in a circuit, for example, will likely appear within the circuit to have a certain amount of inductance and resistance, due in part to the inductance and capacitance of the conductive leads that connect the capacitor to other components as well as from the capacitor's own imperfections. Further, even plain wires are imperfect conductors and have resistance, capacitance, and inductance, and cannot conduct electricity faster than some fraction of the speed of light.

These effects are typically factored into circuit design tools by using a top-level simulation of a circuit to verify that the propagation time of various signals through transmission lines and through components having inductance and capacitance is sufficiently fast through all parts of the circuit to ensure proper synchronization and timing between each component.

It is therefore desirable to consider circuit propagation timing when designing a circuit.

### SUMMARY

The present invention in one embodiment provides a system and method for laying out an electronic circuit such as an integrated circuit comprising two or more subcircuits, via a process comprising estimating signal propagation time in an interface between a source and a destination subcircuit, calculating a margin time based on the difference between a clock period and the estimated signal propagation time, and distributing the calculated margin time to at least one of the source and destination subcircuits.

### BRIEF DESCRIPTION OF THE FIGURES

FIG. 1 is a flowchart of an example method of practicing an example embodiment of the invention.

FIG. 2 is a flowchart of a method of distributing available margin time to subcircuits, consistent with an example embodiment of the invention.

FIG. 3 is a pseudocode listing illustrating calculation of available margin time, consistent with an example embodiment of the invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the extent or scope of the present invention. The following detailed description is, therefore, not to be taken in a limiting sense, and the scope of the invention is defined only by the appended claims.

The present invention in some embodiments addresses the need to consider propagation delays such as transmission line effects and reactive impedances in circuit design and layout for complex circuits comprising two or more subcircuit elements. One such example comprises estimating signal propagation time in an interface between a source and a destination subcircuit, calculating a margin time based on the difference between a clock period and the estimated signal propagation time, and distributing the calculated margin time to at least one of the source and destination subcircuits.

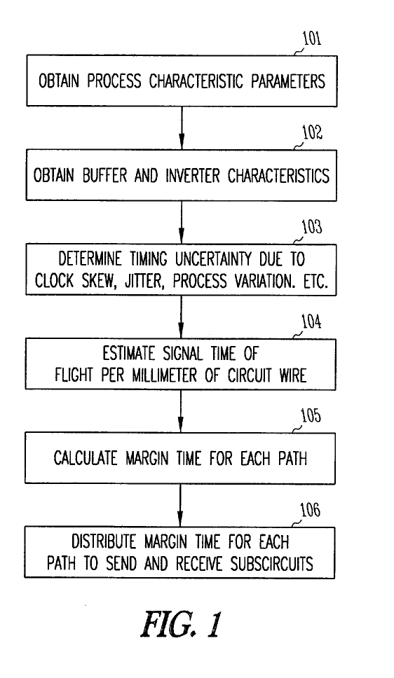

FIG. 1 is a flowchart illustrating one example method of practicing an embodiment of the present invention, and shows how available margin time can be assigned to subcircuits during a circuit layout optimization to make use of margin time within subcircuit elements of a circuit to allow faster circuit operation or to ease placement or layout constraints for subcircuit placement within the circuit.

At 101, the process characteristic parameters for the circuit are obtained. The process parameters in some examples include semiconductor characteristics for the semiconductor process or set of parameters that will be used to create the completed circuit, and includes such things as resistance, line impedance, and other characteristics of the semiconductor devices produced using a certain set of semiconductor manufacturing processes or specifications.

Similarly, the characteristics of typical input and output devices such as buffer amplifiers and inverters are characterized at 102, and in various embodiments include characteristics such as input or output impedance, switching time, slew rate, and other such electrical parameters. Also, timing uncertainty due to other factors such as jitter or clock skew is considered at 103, which enables the process to consider imperfections in the clock used to drive the subcircuits.

The subcircuits will typically be connected via one or more wire paths, linking a sending or source element of one subcircuit to a receiving or destination element in the other subcircuit. The link between subcircuits is typically a thin conductive trace formed on a nonconductive substrate, such as a polysilicon or metal wire connection in an integrated circuit or a wire connection on a circuit board or multi-chip module. The signal propagates along the conductors coupling the subcircuits at a finite speed that varies according to the process parameters obtained at 101, resulting in a time of flight per unit distance that can be estimated at 104. The time of flight per unit length of circuit wire will typically be a significant fraction of the speed of light, which despite being very fast can be a significant amount of time relative to a clock period or other circuit events. The time of flight per unit length is determined in some embodiments by evaluation of the semiconductor process characteristics, and by characteristics of buffers and inverters built using a certain semiconductor process.

An available margin time for each path is calculated at 105, and is based on the time available during a clock cycle not consumed by factors such as wire delay, gate switching delay, setup time, and timing uncertainty such as clock jitter. Setup time is the time that a signal must arrive in a sequential logic circuit before a clock transition for the sequential logic circuit to properly evaluate the signal on the clock transition. This available margin time is therefore available for use in improving the performance of the circuit, or in easing constraints such as physical subcircuit placement limitations. For example, if a time of flight of 150 picoseconds per millimeter of wire is calculated and 500 picoseconds of margin time is available, the subcircuits can be placed just over three millimeters farther apart than they could using the original layout constraints, or the subcircuits can operate 500 picoseconds faster between the sending and receiving subcircuits.

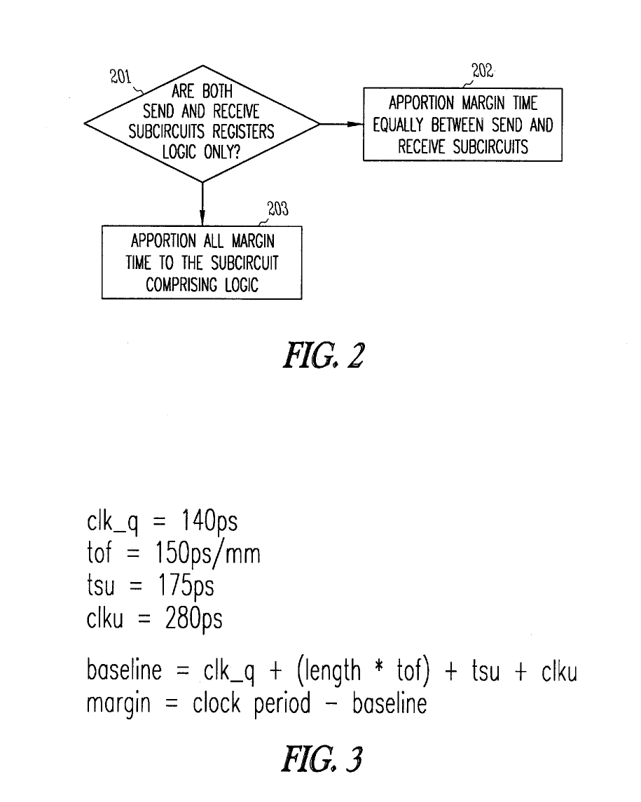

In this example, the available margin time is distributed at 106 between the send and receive subcircuits, such that the time can be used to speed up operation of at least one of the subcircuits or benefit the subcircuit in another way such as to reduce power consumption. FIG. 2 shows an example of one method of distributing available margin time between a sending and a receiving subcircuit, depending on the nature of the subcircuit's interface. At 201, the interfaces to both the send and receive subcircuits are examined to determine whether the subcircuit interfaces are both registers, both logic, or comprise a mix of a register on one side and logic on the other side. If both the send and receive circuit interface circuitry comprise registers only or logic only at 201, the available margin time is split equally between the subcircuits at 202. If the send and receive subcircuit interfaces are not both the same type, they must be one each of a register interface and a logic interface, and all the available margin time is apportioned to the subcircuit having a logic interface at 203.

This method favors apportioning available margin time to subcircuit interfaces having logic at the interface, and enables the subcircuit with the logic interface to use the available margin time to ease internal subcircuit constraints on logic speed, power consumption, and timing. Such a method enables constraint generation for two or more subcircuits early in the design process, without requiring a completed circuit first be analyzed using a top-level optimization process as is often required in standard time budgeting methods used in circuit layout and optimization. The boundary constraints for the various subcircuits comprising a larger circuit can therefore be used earlier in the design process to enable early identification of problems, and to increase efficiency and accuracy in circuit layout.

Generic computer-aided design tools used to lay out complex circuits such as the integrated circuits or chips found in modern computers and other devices have traditionally generated top-level constraints for circuits based on a complete top-level optimization of the entire circuit. This step was traditionally needed to be completed before any sub-circuit optimization was possible, so that the top-level constraints of the circuit as a whole would be factored in to the subcircuit optimization. This process was time consuming, and was often too late in the design process to have a significant effect on design of the circuit as a whole—subchip constraints were generated late enough in the design cycle that problems were often identified only after an entire circuit was laid out, and the solutions to the problems often involved fixes such as rework or top-level design reset that were less than optimal.

In larger circuit designs especially, significant challenges are encountered when a top level optimization must be performed before generating constraints for subcircuit layout, often costing weeks per optimization and months per circuit to produce a circuit meeting optimization goals or constraints. Some embodiments of the invention seek to remedy the inefficiency of constraint generation after top-level optimization of a circuit layout by using subcircuit analysis as described in FIGS. 1 and 2, and as recited in the claims. Various embodiments generate subchip constraints early in the design and layout process, and don't require a top-level optimization of a completed circuit to produce useful constraint results. Data such as buffer and register characteristics, semiconductor process characteristics, and knowledge of wire lengths and logic structure enable very accurate estimates of time consumed during the initial subcircuit placement stage, and enables distribution of available margin time to the internal circuitry of various subcircuits or to ease placement constraints for the various subcircuits in an optimized circuit.

One example embodiment of such a system uses a commercial integrated circuit layout and design program such as IBM's ChipBench or Magma's Mantle layout software. A script obtains data and performs a method such as the example shown in FIG. 3, which illustrates a simplified version of determination of available margin time based on circuit parameters. The clk_q parameter denotes the time taken for a register to lock a value, which in this example is 140 picoseconds. The tof parameter is the time of flight for a signal traveling through a conductor consistent with the semiconductor process parameters of the circuit, which in this case is 150 picoseconds per millimeter of wire. In addition to register output delay, a register setup time of 175 picoseconds is factored in as the tsu parameter, accounting for register operations such as hold, clear, etc. Finally, a clock uncertainty figure clku is obtained or calculated to reflect the total uncertainty in the clock signal, such as due to jitter, slew rate, and other such effects, and is 280 picoseconds in this example.

These parameters are used to calculate a baseline time, which is in essence the sum of each parameter except that the time of flight is multiplied by the wire length estimated for coupling between the subcircuits. This baseline time is subtracted from a clock period to obtain an available margin time, which is in effect time that can be allocated to ease subcircuit placement constraints or to ease logic design constraints within a subcircuit.

These examples show in some embodiments how subcircuit constraints can be evaluated without first performing a top-level circuit optimization in designing a circuit having multiple subcircuits, resulting in a faster and more efficient circuit layout process. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A method of laying out an electric circuit, comprising:
estimating signal propagation time in an interface between a source and a destination subcircuit;
calculating a margin time based on the difference between a clock period and the estimated signal propagation time; and
distributing the calculated margin time to at least one of the source and destination subcircuits.

2. The method of laying out an electric circuit of claim 1, wherein estimating signal propagation time comprises estimation of at least one of transmission line delay, clock uncertainty, buffer delay, inverter delay, and parasitic impedance delay.

3. The method of laying out an electric circuit of claim 1, wherein delay is estimated based on circuit process parameters.

4. The method of laying out an electric circuit of claim 1, wherein the distributed margin time is used for at least one of relaxing subcircuit placement constraints or speeding up operation of the circuit.

5. The method of laying out an electric circuit of claim 1, wherein distributing the calculated margin time to at least one of the source and destination subcircuits comprises distributing the margin time based on whether source or destination circuit interfaces comprises a register or logic.

6. The method of laying out an electric circuit of claim 6, wherein distributing the margin time based on whether the source or destination circuits comprises a register or logic comprises:
distributing the margin time equally between the source and destination subcircuits if both subcircuit interfaces comprise registers or both subcircuit interfaces comprise logic; and
distributing the margin to the subcircuit comprising a logic interface if one subcircuit interface comprises logic and one subcircuit interface comprises a register.

7. A machine-readable medium with instructions encoded thereon, the instructions when executed operable to cause a computerized system to:
estimate signal propagation time in an interface between a source and a destination subcircuit;
calculate a margin time based on the difference between a clock period and the estimated signal propagation time; and
distribute the calculated margin time to at least one of the source and destination subcircuits.

8. The machine-readable medium of claim 1, wherein estimating signal propagation time comprises estimation of at least one of transmission line delay, clock uncertainty, buffer delay, inverter delay, and parasitic impedance delay.

9. The machine-readable medium of claim 1, wherein delay is estimated based on circuit process parameters

10. The machine-readable medium of claim 1, wherein the distributed margin time is used for at least one of relaxing subcircuit placement constraints or speeding up operation of the circuit.

11. The machine-readable medium of claim 1, wherein distributing the calculated margin time to at least one of the source and destination subcircuits comprises distributing the margin time based on whether source or destination circuit interfaces comprises a register or logic.

12. The machine-readable medium of claim 11, wherein distributing the margin time based on whether the source or destination circuits comprises a register or logic comprises:
distributing the margin time equally between the source and destination subcircuits if both subcircuit interfaces comprise registers or both subcircuit interfaces comprise logic; and
distributing the margin to the subcircuit comprising a logic interface if one subcircuit interface comprises logic and one subcircuit interface comprises a register.

13. An electronic circuit layout system, comprising:
a simulation module operable to estimate signal propagation time in an interface between a source and a destination subcircuit, and to calculate a margin time based on the difference between a clock period and the estimated signal propagation time; and
a layout module operable to distribute the calculated margin time to at least one of the source and destination subcircuits.

14. The electronic circuit layout system of claim 13, wherein estimating signal propagation time comprises estimation of at least one of transmission line delay, clock uncertainty, buffer delay, inverter delay, and parasitic impedance delay.

15. The electronic circuit layout system of claim 13, wherein delay is estimated based on circuit process parameters.

16. The electronic circuit layout system of claim 13, wherein the distributed margin time is used for at least one of relaxing subcircuit placement constraints or speeding up operation of the circuit.

17. The electronic circuit layout system of claim 13, wherein distributing the calculated margin time to at least one of the source and destination subcircuits comprises distributing the margin time based on whether source or destination circuit interfaces comprises a register or logic.

18. The electronic circuit layout system of claim 17, wherein distributing the margin time based on whether the source or destination circuits comprises a register or logic comprises:
distributing the margin time equally between the source and destination subcircuits if both subcircuit interfaces comprise registers or both subcircuit interfaces comprise logic; and
distributing the margin to the subcircuit comprising a logic interface if one subcircuit interface comprises logic and one subcircuit interface comprises a register.
